(19) United States
(12) Patent Application Publication
(10) Pub. No.: US 2009/0021706 A1
(43) Pub. Date: Jan. 22, 2009

(54) Immersion fluid containment system and method for immersion lithogtraphy

(75) Inventor: Michael Sogard, Menlo Park, CA (US)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/921,228

(22) PCT Filed: May 16, 2006
(86) PCT No.: PCT/US2006/018859

§ 371 Date: Jan. 24, 2008

Related U.S. Application Data
(60) Provisional application No. 60/686,049, filed on Jun. 1, 2005.
(60) Provisional application No. 60/780,821, filed on Mar. 10, 2006.

(51) Int. Cl. G03B 27/42; G03B 27/52

(52) U.S. Cl. 355/30; 355/53

(57) ABSTRACT

A ferrofluid is provided adjacent to the immersion area between a projection optical system (PL) and substrate and receives a magnetic force so as to form a ferrofluidic seal (100) adjacent to the immersion area so as to inhibit immersion liquid from escaping from the gap between the projection optical system and substrate. The ferrofluid can be a fluid having a colloidal suspension of ferromagnetic particles in it.

### RELATED APPLICATION

This application claims the benefit of U.S. Provisional Patent Application No. 60/686,049 filed Jun. 1, 2005 and U.S. Provisional Patent Application No. 60/780,821 filed Mar. 10, 2006. The entire disclosure of each of the prior applications is hereby incorporated by reference herein in its entirety.

### BACKGROUND

Aspects of this invention relate to containment of immersion fluid in immersion lithography apparatus and methods.

In immersion lithography, a liquid such as, for example, pure water, fills the space between the last optical element of the projection system and the substrate (for example, a wafer) onto which a pattern is projected. Filling the space with liquid (hereafter referred to as immersion liquid) enables the numerical aperture (NA) of the lithography system to be increased. It is possible to increase the NA so that it is greater than 1.0. For 193 nm wavelength exposure light, pure water is one preferred immersion liquid.

The immersion liquid typically is provided to the gap between the projection optical system and a portion of the substrate by an immersion liquid supply system having one or more liquid supply nozzles and one or more liquid removal nozzles. Examples of such systems are provided in WO99/49504, the disclosure of which is incorporated herein by reference in its entirety.

It is highly desirable to contain the immersion liquid in the vicinity of the gap between the projection optical system and the substrate. However, when the lithography system is a scanning exposure lithography system in which the substrate is moved relative to the projection system, the area of the substrate over which the immersion liquid is contained changes as the substrate moves, which can leave droplets or films of the immersion liquid on the substrate.

A number of problems can arise due to immersion liquid droplets or films being left on the substrate. The droplets or films can perturb the fluid if movement of the substrate carriers such droplets or films into the immersion fluid that is maintained between the projection optical system and substrate, creating bubbles in the fluid, or creating more droplets or films. Fluid evaporating from the substrate can cause thermal problems because of the large heat of vaporization of such fluid. Because it is desirable to maintain the atmosphere around the substrate at a relatively constant temperature and humidity, vaporization of any droplets or films remaining on the substrate is undesirable. Any vapor caused by the evaporated liquid can affect the refractive index of air in the lithography tool chamber, causing stage interferometer errors, for example. In addition, film, droplets, bubbles or vapor may affect autofocus operation.

Efforts have been made to design the liquid supply system (for example, the liquid supply and removal nozzles) so as to contain the immersion liquid in the gap below the projection optical system. However, as substrate stage speeds increase, an instability arises, particularly for photoresists having low contact angles with the immersion liquid. Thus, the spreading of the immersion liquid from the area below the projection lens may occur at high substrate speeds and/or with low contact angle photoresists. Furthermore, if a fluid other than water is used as the immersion liquid, it may become more difficult to contain such fluid. It is thus desirable to provide a separate way of containing the immersion liquid in the area where exposure takes place between the projection optical system and the substrate.

A wiper or “squeegee” surrounding the gap area or merely providing a barrier in the scanning direction might be effective in containing the immersion liquid. However, no solid structure is permitted to contact the substrate because it would scratch and otherwise adversely affect the photoresist and other materials on the substrate.

WO 2004/090634 provides a fluid barrier that can surround the projection system so as to maintain the immersion liquid in the area between the projection system and substrate using liquid and/or gas to create the fluid barrier that contains the immersion liquid. The disclosure of WO 2004/090634 is incorporated herein by reference in its entirety.

WO 2004/093159 discloses providing a ferromagnetic powder in the immersion fluid to improve the magnetic responsiveness of the immersion fluid and then applying a magnetostatic force to an area surrounding the projection system to increase the viscosity of the immersion fluid around the area between the projection optical system and the substrate so as to assist in containing the immersion liquid. The disclosure of WO 2004/093159 is incorporated herein by reference in its entirety.

### SUMMARY

A ferrofluid, or magnetic fluid, is provided adjacent to the immersion area between a projection optical system and substrate and receives a magnetic force so as to form a ferrofluidic seal adjacent to the immersion area so as to inhibit immersion liquid from escaping from the gap between the projection optical system and substrate. The ferrofluid can be a fluid having a colloidal suspension of ferromagnetic particles in it. Properties, behavior and applications of ferrofluids are described in the monograph Ferrohydrodynamics by R. E. Rosensweig, Dover Press, 1997.

When the projection optical system is included in a scanning exposure apparatus, in which the substrate is moved relative to the projection optical system during exposure of the substrate, the ferrofluidic seal preferably is located adjacent to at least one side of the immersion area. According to a preferred embodiment, the ferrofluidic seal extends in a direction perpendicular to the scanning direction of the substrate during exposure. Even more preferably, the ferrofluidic seal is located adjacent to at least two opposite sides of the immersion area. Even more preferably, the ferrofluidic seal extends entirely around the immersion area. The ferrofluidic seal can be continuous or discontinuous.

According to some embodiments, the ferrofluid is immiscible with the immersion fluid. According to some embodiments, the ferrofluid has a density that is equal to or greater than the density of the immersion fluid. Such characteristics prevent mixing of the ferrofluid and the immersion fluid and enhance the ability of the ferrofluid to inhibit leakage of the immersion fluid even when the substrate is moved at a high speed.

According to some embodiments, the ferrofluidic seal includes the ferrofluid and a magnetic circuit that draws the ferrofluid to a location adjacent to the immersion area. The magnetic circuit can include a high magnetic permeability plate located below the substrate (for example, in the chuck that holds the substrate in place during exposure) such that the substrate is disposed between the projection optical system and the plate. The magnetic circuit also can include high magnetic permeability pole pieces located adjacent to the projection optical system and facing the surface of the substrate that is to be exposed. A magnet such as a permanent magnet also can be provided so as to magnetize the pole pieces.

In another embodiment, the pole pieces and magnet are provided without the high magnetic permeability plate. According to this alternative embodiment, the ferrofluid is located between the pole pieces and is lifted off the substrate by the pole pieces when the pole pieces and substrate are moved away from each other, for example, to facilitate exchange of one substrate for another. In this embodiment, the magnetic circuit can include an electromagnet located below the substrate that is selectively activated when it is desired to form the ferrofluidic seal. According to another alternative, a pump is provided to control a pressure within a chamber formed between the pole pieces so as to selectively (a) increase the pressure in the chamber to allow the ferrofluid to contact the surface of the substrate that is to be exposed and thus form the ferrofluidic seal and (b) decrease the pressure in the chamber to cause the ferrofluid to move into the chamber and out of contact with the substrate, for example, to facilitate substrate exchange.

According to some embodiments, a plurality of the ferrofluidic seals are disposed in series and are located progressively farther away from the immersion area. These embodiments provide additional resistance to the escape of the immersion fluid from the gap between the projection optical system and the substrate. In addition, a pressure control system can be provided so as to apply pressure between the ferrofluidic seals to provide further resistance to leakage of immersion fluid.

According to some embodiments, a ferrofluid supply system is provided to selectively supply ferrofluid to, and remove the ferrofluid from, the ferrofluidic seal.

Other aspects of the invention relate to exposure apparatus incorporating the ferrofluidic seal, and to methods of containing immersion fluid and of performing lithographic exposure in which the ferrofluidic seal is utilized.

### BRIEF DESCRIPTION OF THE DRAWINGS

The invention will be described in conjunction with the accompanying drawings of exemplary embodiments in which like reference numerals designate like elements, and in which:

FIG. 1 schematically shows elements of one type of ferrofluidic seal;

FIG. 2 illustrates the effects of a pressure difference created across a ferrofluidic seal;

FIG. 3 illustrates one application of a ferrofluidic seal to contain immersion liquid in an immersion lithography system;

FIG. 4 schematically shows another type of ferrofluidic seal in which a circuit is completed across the gap where the ferrofluid is located;

FIGS. 5A-7B schematically illustrate other embodiments in which the ferrofluidic seal includes a circuit completed across the gap where the ferrofluid is located;

FIG. 8 schematically illustrates how several ferrofluidic seals in series can be used to increase the pressure imbalance that the seal in contact with the immersion liquid can withstand;

FIG. 9 shows a ferrofluidic seal containing the flow of an immersion liquid;

FIGS. 10A-10D show the interface between a ferrofluidic seal and immersion liquid under different conditions;

FIGS. 11A-11B schematically show a ferrofluidic seal surrounding an immersion liquid nozzle;

FIG. 12A shows a different arrangement in which four linear ferrofluidic seals are provided to surround an immersion liquid nozzle;

FIG. 12B shows another arrangement in which only two linear ferrofluidic seals are provided on opposite sides of an immersion liquid nozzle;

FIGS. 13A-13B illustrate one technique for supplying the ferrofluid into the magnetic field area;

FIGS. 14A-14B illustrate an arrangement in which the ferrofluid is circulated through a ferrofluidic seal;

FIG. 15 shows the scattered radiation intensity from a 10 nm particle illuminated by 193 nm light in the Rayleigh scattering approximation;

FIG. 16 is a flow diagram illustrating an exemplary process by which semiconductor devices are fabricated using an immersion lithography apparatus incorporating features of the invention;

FIG. 17 is a flowchart of the wafer processing step shown in FIG. 16;

FIG. 18 schematically shows a modified version of the FIG. 4 ferrofluidic seal; and

FIGS. 19A-19G schematically illustrate further embodiments of ferrofluidic seals according to aspects of the invention.

### DETAILED DESCRIPTION OF EMBODIMENTS

Ferrofluidic seals, in which a ferrofluid is constrained by a magnetic field, are used as vacuum seals for rotary or linear bearings and as rotary seals in disk drives and air blowers. Examples of ferrofluidic seals can be found in U.S. Pat. No. 4,407,518; U.S. Pat. No. 4,502,700; U.S. Pat. No. 4,630,943; U.S. Pat. No. 4,817,964; U.S. Pat. No. 4,830,384; U.S. Pat. No. 5,165,701; U.S. Pat. No. 6,543,782; U.S. Pat. No. 6,558,042; U.S. Pat. No. 6,833,780; M. Perry and T. Jones, IEEE Trans. Magnetics MAG-12, 798 (1976); R. Williams and H. Malsky, IEEE Trans. Magnetics MAG-16, 379 (1980); Zou Jibin and Lu Yongpin, IEEE Trans. Magnetics 28, 3367 (1992); J. Walowit and O. Pinkus, ASLE Trans. 24, 533 (1981).

A ferrofluid is a liquid with a colloidal suspension of ferromagnetic particles. The liquid can be, for example, water, hydrocarbons, fluorocarbons, esters, polyphenylethers or di-esters. The ferromagnetic particles can be, for example, ferrite, cobalt, iron-cobalt alloy, or paramagnetic salts, such as FeCl₃, MnCl₃ or Ho(NO₃)₃.

It also is preferable to include a dispersant in the ferrofluid to prevent clumping of the ferromagnetic particles. Dispersants include, for example, oleic acid, perfluoropolyether acid and polyphosphoric acid derivative. The choice of dispersant will depend to some extent on the properties of the liquid the magnetic particles are dispersed in. The particle size for ferrite typically is about 10 nm or smaller. Larger ferrite particles tend to clump together because of attractive magnetic moment interactions between them. At room temperature, Brownian motion combined with a dispersant layer is sufficient to keep the particles from clumping.

Ideally, the ferrofluid should be immiscible with the immersion fluid (typically water), and it must be compatible with the resist provided on the substrate being exposed. Preferably, the ferrofluid has a density that is equal to or higher than the density of the immersion fluid to enhance the ferrofluid's ability to constrain movement of the immersion fluid from the gap between the projection optics and the substrate. A typical ferrofluidic seal can withstand a transverse pressure of several psi. Placing several ferrofluidic seals in series also improves resistance to pressure differentials.

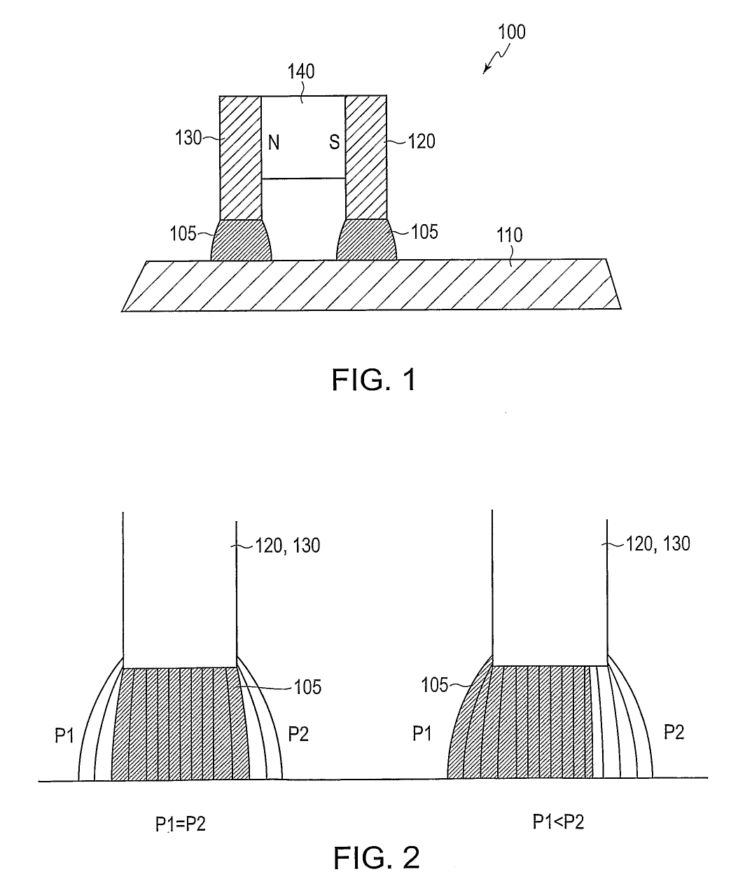

FIG. 1 shows components of one type of ferrofluidic seal 100 according to an embodiment of the invention. A magnetic circuit is formed by a high magnetic permeability plate 110, high magnetic permeability pole pieces 120 and 130, and a permanent magnet 140. The ferrofluid 105 is drawn into the most intense regions of the magnetic field as illustrated in FIG. 1. In many practical applications, the magnetic field is strong enough to saturate the magnetization of the ferrofluid 105, so its permeability is approximately 1.0. In that case, the presence of the ferrofluid 105 has little effect on the magnetic field lines created by the magnetic circuit. The surfaces of the ferrofluid 105 then coincide with the magnetic field lines.

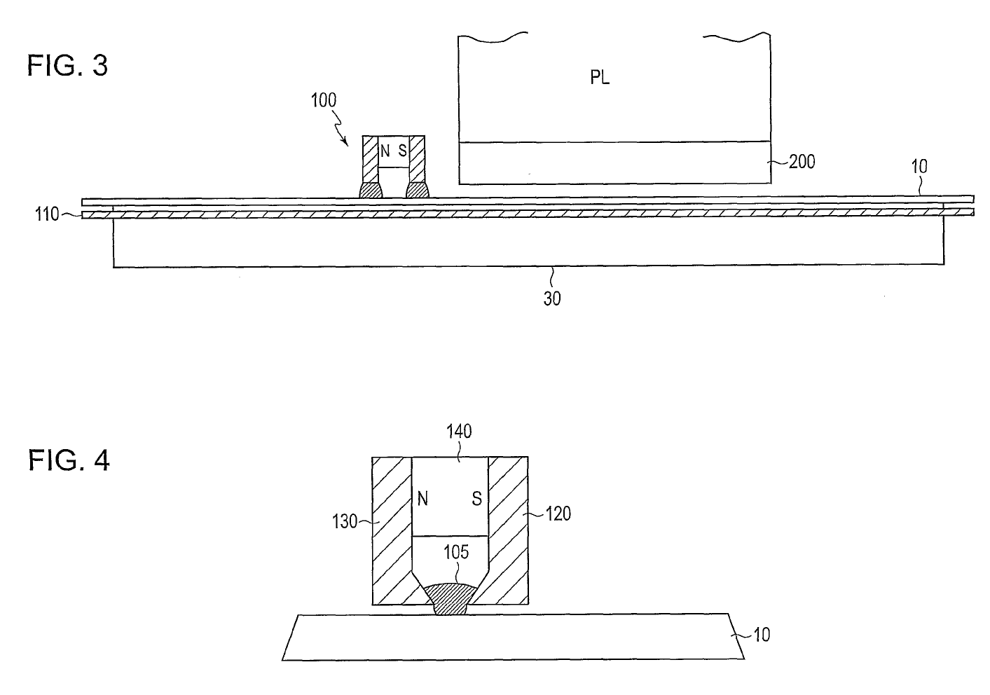

FIG. 2 illustrates what happens when a pressure difference is created across the ferrofluid 105. The left-side of FIG. 2 shows an example in which the pressure on either side of the ferrofluid 105 is equal (P1═P2). The right-side of FIG. 2 shows an example in which the pressure on one side of the ferrofluid 105 is greater than on the other side (P1<P2). As shown in FIG. 2, when a pressure difference is created across the ferrofluid, the ferrofluid moves so that one surface is at a lower magnetic field strength than the other. With respect to the right-side of FIG. 2, because P2>P1, the ferrofluid 105 moves so that the surface of the ferrofluid adjacent to P1 is at a lower magnetic field strength than the surface of the ferrofluid adjacent to P2. This creates a net magnetic force on the fluid 105 that opposes the pressure difference at the two surfaces. If the pressure difference becomes too high, the ferrofluid is expelled from the gap between the pole pieces 120, 130 and the plate 110. To a good approximation, the pressure difference is related to the magnetic field H and the ferrofluid magnetization M by the relation shown in equation (1):

$${P}_{2} - {P}_{1} = {μ}_{0} {\int }_{H 1}^{H 2} M d H \qquad ( 1 )$$

where μ₀ is the permeability of free space (4π×10⁻⁷ H/m). The seal will fail when the surface of the ferrofluid is pushed out to the edge of the magnetic field where it is no longer retained by the field, i.e., where H1≈0. Thus, the burst pressure is approximately

$$Δ {P}_{burst} = {μ}_{0} {\int }_{0}^{H 2} M d H \qquad ( 2 )$$

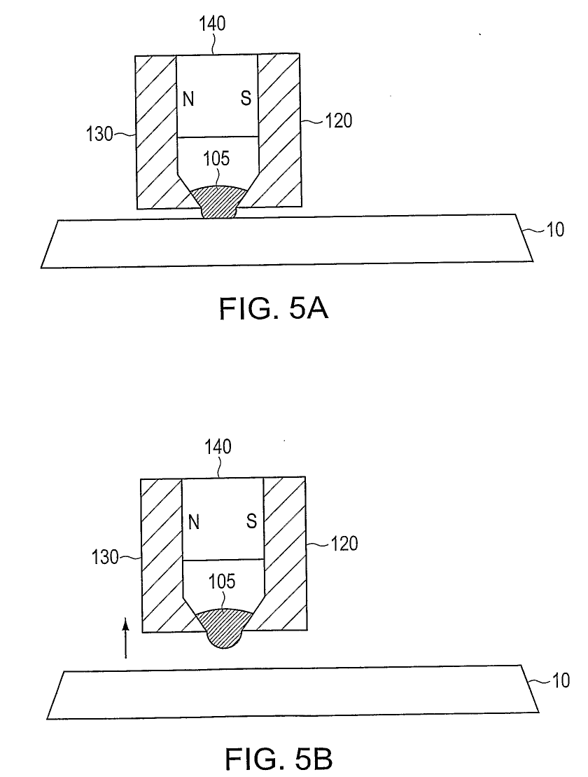

FIG. 3 illustrates an application of the FIG. 1 ferrofluidic seal 100 to an immersion lithography apparatus in order to contain the immersion fluid in that apparatus. The lithography apparatus includes, for example, a projection optical system PL having an immersion liquid supply system 200 that supplies an immersion fluid such as water to an immersion area located in the gap between the last optical element of the projection optical system PL and the upper surface of a substrate 10 (such as a wafer or glass plate on which exposure is to take place) and in which exposure takes place. Examples of immersion nozzles that supply fluid to the immersion area are disclosed in WO99/49504, WO2004/86468 and WO2004/90634, the disclosures of which are incorporated herein by reference in their entireties. The substrate 10 is mounted on a substrate stage, and in particular, is held to that stage by a wafer chuck 30 provided at the top of the substrate stage. The wafer chuck can use, for example, vacuum to hold a wafer or other substrate in place. In the FIG. 3 embodiment, the high magnetic permeability plate 110 of the ferrofluidic seal 100 is provided in the wafer chuck 30. This may be inconvenient because it increases the weight of the wafer chuck, and thus the weight of the substrate stage, which must be precisely and rapidly moved. In general, it is desirable to minimize the weight of the moving portions of the substrate stage.

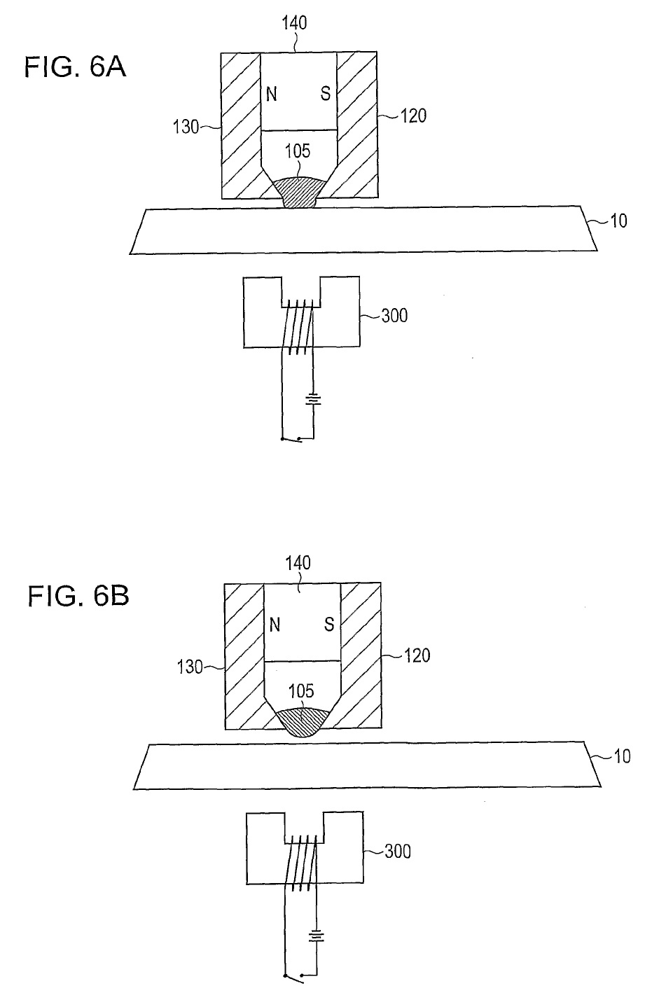

Accordingly, FIG. 4 shows another embodiment of ferrofluidic seal in which the magnetic circuit is completed across the gap between the pole pieces 120 and 130 where the ferrofluid 105 is located. In this embodiment, the ferrofluid 105 bulges out below the bottom of the pole pieces 120, 130, partly following the shape of the magnetic field lines and partly sagging from gravitational forces on the ferrofluid 105. As noted above, this embodiment is advantageous because no high magnetic permeability plate is needed below the substrate.

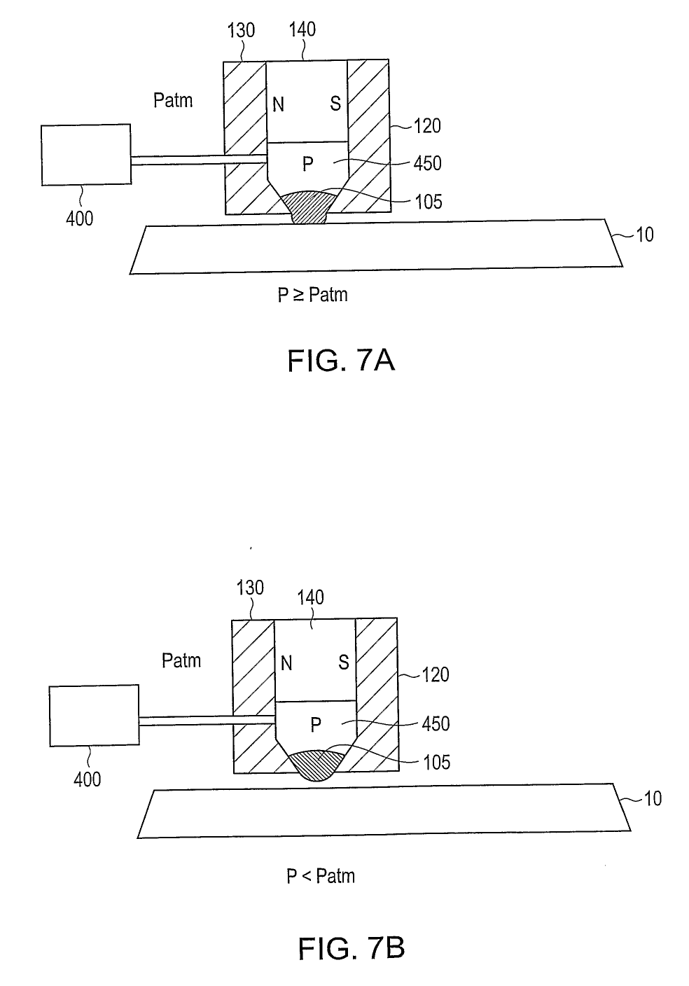

FIG. 5A shows the pole pieces 120, 130 in a first position in which they are very close to the substrate 10 so that the ferrofluid 105 contacts the upper surface of the substrate 10 so as to form the ferrofluidic seal, whereas FIG. 5B shows a second position of the pole pieces 120, 130 relative to the substrate 10 in which the ferrofluidic seal is broken. As shown in FIG. 5B, when the pole pieces 120, 130 are moved away from the substrate 10, the ferrofluid 105 comes out of contact with the substrate 10, thus breaking the ferrofluidic seal. Meanwhile, the ferrofluid 105 is maintained between the pole pieces 120, 130 by magnetic forces. This provides a very convenient mechanism for exchanging substrates 10 without requiring removal of the ferrofluid 105 from the system.

FIGS. 6A and 6B show an arrangement similar to the arrangement of FIGS. 5A and 5B, except that an electromagnet 300 is disposed below the substrate 10, for example, in the wafer chuck. The electromagnet 300 is used to enhance movement of the ferrofluid 105 out of the chamber formed between the pole pieces 120, 130 so that the ferrofluid 105 even more strongly engages with the substrate 10 when it is desired to form the ferrofluidic seal.

FIG. 6A shows the electromagnet 300 in the ON state, whereas FIG. 6B shows the electromagnet 300 in the OFF state. This arrangement can permit the ferrofluidic seal to be formed against the substrate 10 and released from the substrate without moving the pole pieces 120, 130 away from the substrate 10. The electromagnet 300 may be located beneath the moving parts of the substrate stage, so no impairment of the substrate stage performance occurs. In another embodiment, not shown, the electromagnet may be located above the permanent magnet, or surrounding it. In this case, the ferrofluid would form a seal with the substrate with the electromagnet in the OFF state. The seal is broken with the electromagnet in the ON state.

FIGS. 7A and 7B show another embodiment in which a pump 400 is added to the embodiment of FIGS. 5A and 5B to control movement of the ferrofluid 105 out of (FIG. 7A) and into (FIG. 7B) a chamber 450 formed between the pole pieces 120, 130 and end plates and/or seals (not shown), so as to selectively form and release the ferrofluidic seal. When the pump 400 increases the pressure within chamber 450, the ferrofluid 105 moves out of the chamber 450 and into contact with the substrate 10 to form the ferrofluidic seal as shown in FIG. 7A. For example, the ferrofluidic seal is formed when the pressure P within the chamber 450 is equal to or greater than the pressure Patm outside of the pole pieces 120, 130. When the pump 400 decreases the pressure within the chamber 450, for example, such that the pressure P within the chamber 450 is less than Patm, then the ferrofluid 105 moves out of contact with the substrate 10 so as to break or release the ferrofluidic seal as shown in FIG. 7B. Like the embodiment of FIGS. 6A and 6B, the embodiment of FIGS. 7A and 7B does not necessarily require that the pole pieces 120, 130 be moved away from the substrate 10 in order to break the ferrofluidic seal.

The embodiments of FIGS. 6A-B and 7A-B can be used together. In addition, the embodiments of FIGS. 6A-B and 7A-B also can be combined with the embodiment of FIGS. 5A-B (in which the substrate 10 and pole pieces 120, 130 move apart from each other) either individually or together (that is, it is possible to combine all three embodiments of FIGS. 5A-7B).

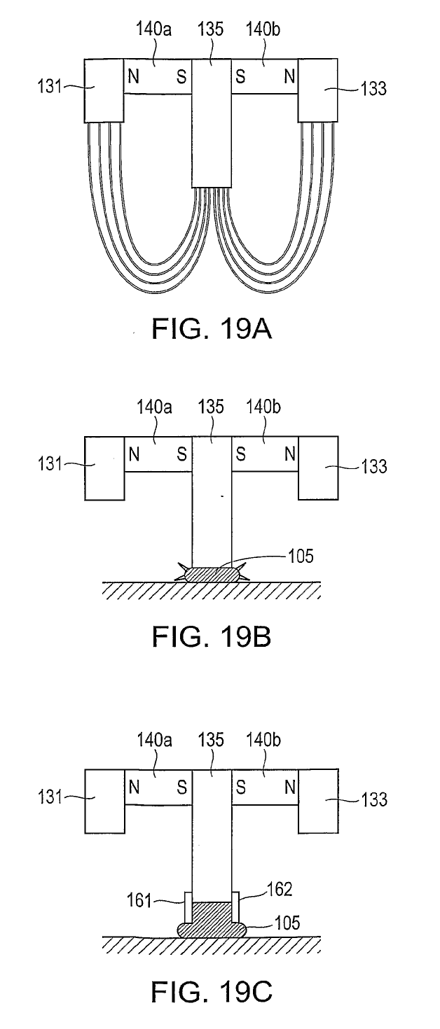

In the embodiment shown in FIG. 4, much of the ferrofluid fills the space between the poles 120 and 130 and does not contribute to forming the ferrofluidic seal. The seal may not be as “stiff” as the FIG. 1 embodiment. As described above, an electromagnet 300 and/or pressurizing the chamber 450 between the poles 120, 130 can enhance the strength of the ferrofluidic seal. Another alternative, shown in FIG. 18, is to provide a non-ferromagnetic plug 160 between the poles 120, 130 to prevent the ferrofluid from filling the space between the poles 120, 130. Preferably the plug material is not wetted by the ferrofluid. This makes recycling of the ferrofluid easier. For the case of a water based ferrofluid, the material would be said to be hydrophobic. Hydrophobic materials typically have a low surface energy. Fluorocarbons such as Teflon are one example.

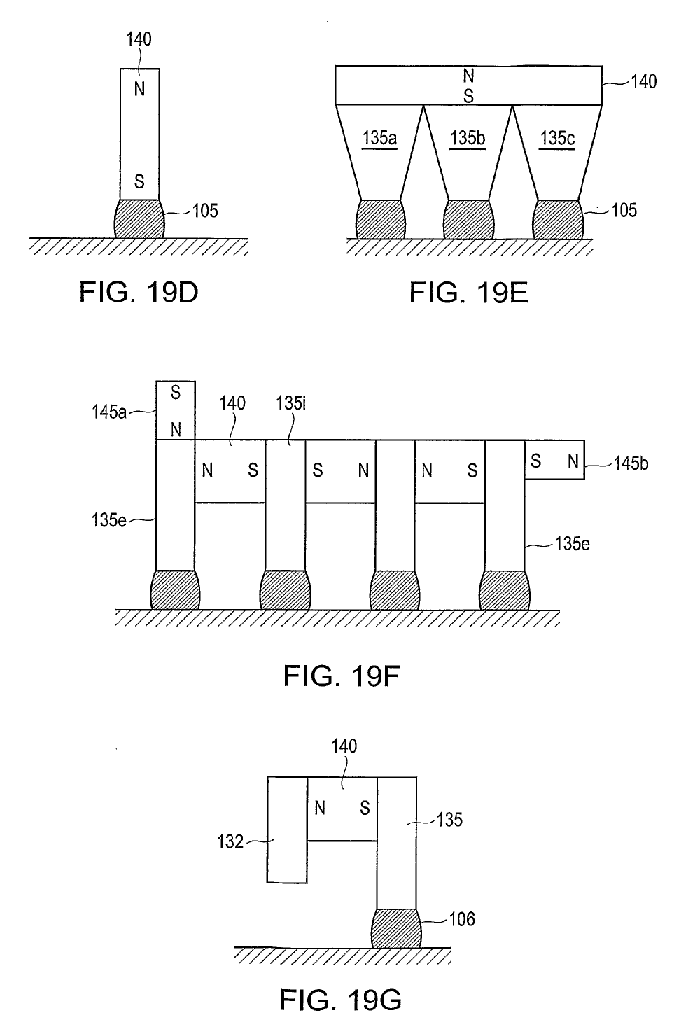

The ferrofluid can move along magnetic field lines, in the absence of a gradient and therefore the FIG. 4 architecture may be less stiff than the FIG. 1 architecture. FIG. 19A shows an architecture that is more like the FIG. 1 architecture and may provide a stiffer seal than the FIG. 4 architecture. Three poles 131, 133 and 135 are provided, with permanent magnets 140a and 140b disposed between the poles as shown. Magnetic flux flows between each of the outer poles 131 and 133 and the inner, central pole 135 as shown in FIG. 19A. As shown in FIG. 19B, the ferrofluid 105 will collect between the surface (substrate) and the bottom of the inner pole 135 to form the ferrofluidic seal. As shown in FIG. 19B, ferrofluidic spikes may occur on the sides of the seal due to a so-called normal field instability. Such spikes arise for magnetic fields having a field component normal to the ferrofluid surface and exceeding a threshold intensity; they can be suppressed by adding non-ferromagnetic plates 161 and 162 to the sides of the inner pole 135, as shown in FIG. 19C. The plates can also shape the seal, providing further stiffening of the seal.

FIGS. 19D-19G show other embodiments of magnetic circuit architectures in which the magnetic field containing the ferrofluid is primarily oriented normal to the substrate surface. In FIG. 19F, auxiliary magnets 145a and 145b provide additional flux primarily to the end pole pieces 135e, so that the flux through the end pole pieces 135e is approximately equal to that of the internal pole pieces 135i. This will ensure the ferrofluid seal conditions will be approximately identical. The internal pole pieces 135i have more flux, because two permanent magnets 140 provide flux to each internal pole piece 135i.

FIG. 19G shows an embodiment in which an auxiliary pole piece 132 is used to shape the ferrofluid seal 106 asymmetrically. This may be advantageous in providing appropriate interface conditions between the ferrofluid and an immersion fluid.

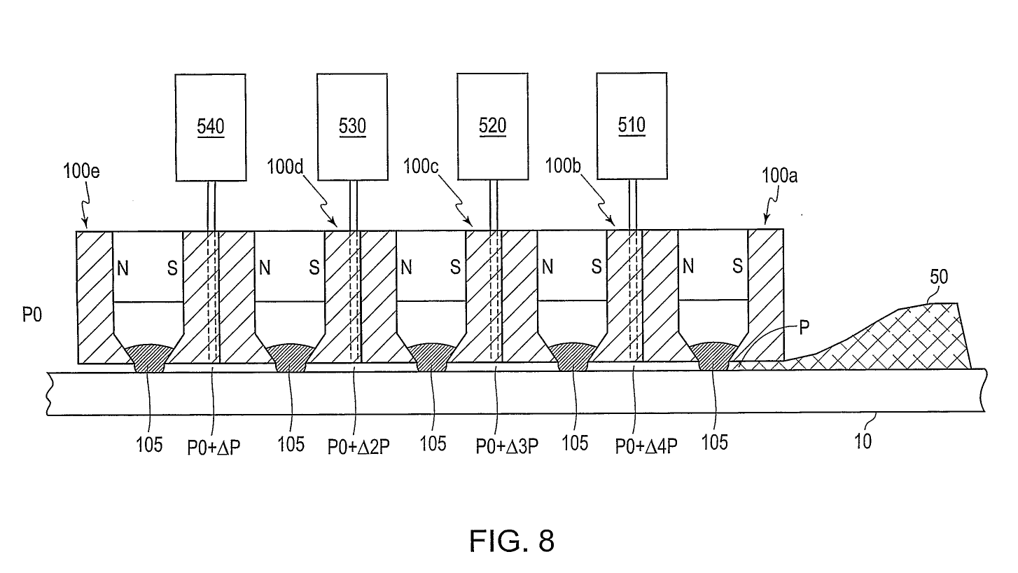

FIG. 8 shows an arrangement in which a plurality of ferrofluidic seals are disposed in series so as to be located progressively farther away from the immersion area where the immersion fluid 50 is located. In particular, first through fifth ferrofluidic seals 100a, 100b, 100c, 100d and 100e are provided in series. Each ferrofluidic seal can be similar to any of the examples illustrated in FIGS. 1-7B, for example. In addition, one or more pumps provide pressurized gas between each of the ferrofluidic seals. In the FIG. 8 embodiment, a first pump 510 provides pressurized gas between ferrofluidic seals 100a and 100b to form a pressure P0+Δ4P between those seals; a second pump 520 provides pressurized gas between ferrofluidic seals 100b and 100c to form a pressure P0+Δ3P between those ferrofluidic seals; a third pump 530 provides pressurized gas between ferrofluidic seals 100c and 100d to form a pressure P0+Δ2P between those ferrofluidic seals; and a fourth pump 540 provides pressurized gas between ferrofluidic seals 100d and 100e to form a pressure P0+ΔP between those ferrofluidic seals. Instead of separate pumps, a single pressurized gas supply system with appropriate pressure control structure (valves, etc.) can be used to supply the pressurized gas at the appropriate pressure between the various ferrofluidic seals. This arrangement can be used to increase the pressure imbalance that the ferrofluidic seal can withstand, and thus is very advantageous when the substrate is moved at high speeds or with high accelerations (for example, due to quick changes in direction of movement of the substrate).

In any of the embodiments described, the permanent magnets shown could be replaced by electromagnets. Furthermore, electromagnets could be added to any of the permanent magnet embodiments to adjust the field strength or field configuration of the permanent magnets, and thus to adjust the ferrofluidic seal properties.

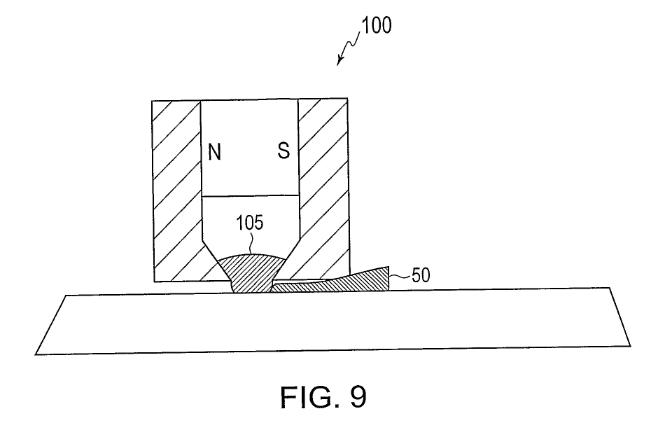

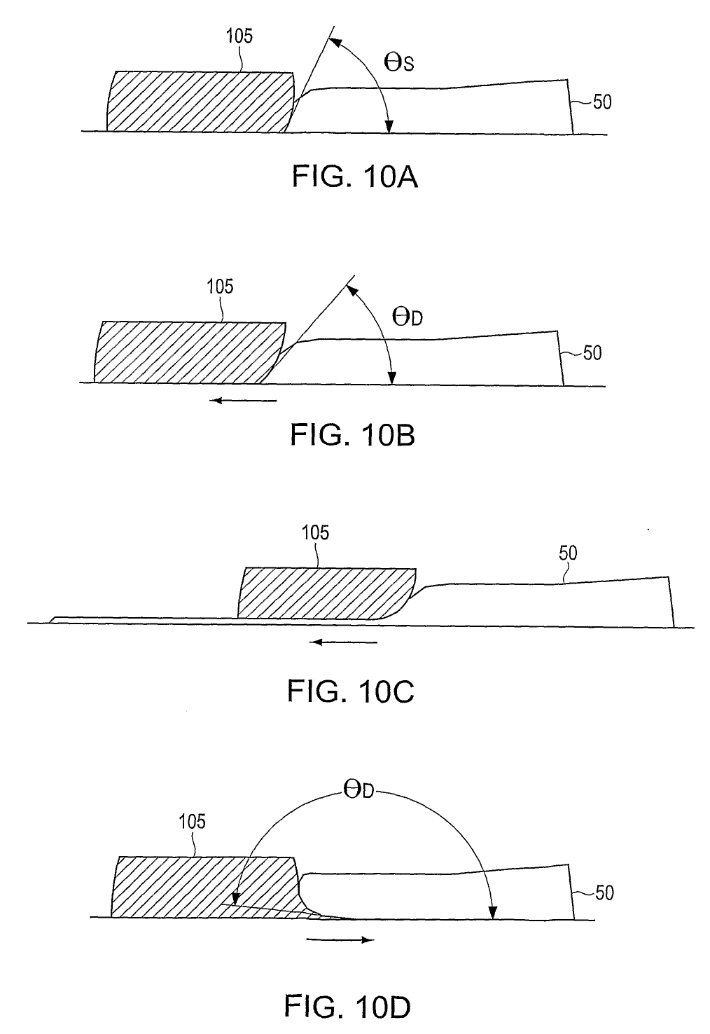

A ferrofluidic seal is shown containing the flow of immersion fluid 50 in FIG. 9. Using the ferrofluid 105 to act as a barrier to another fluid (the immersion fluid 50) introduces some factors not present when a ferrofluid is used as a gas seal. As shown in FIG. 10A, the two fluid interfaces must adjust for their normally different surface tensions. The static contact angle between the wafer and the fluid interface, θ_{S}, depends on the surface tension γ of the two fluids through Young's equation reproduced below as equation (3):

γ_{fi} cos θ_{S}=γ_{sf}−γₛᵢ, (3)

where f and i stand for the ferrofluid and the immersion fluid, respectively, and s stands for the surface of the wafer. However, this expression is modified by the presence of forces from the magnetic field interacting with the ferrofluid. In practical applications, the magnetic forces often dominate the surface tension effects. When the wafer moves, the contact angle will change somewhat to a dynamic value θ_{D} as indicated in FIG. 10B. It is desirable to avoid a situation such as shown in FIG. 10C in which the contact angle goes to zero and the seal fails, causing immersion fluid to flow between the substrate and the ferrofluid and thus leak from the system. It also is desirable to avoid spreading of the ferrofluid 105 into the immersion fluid region when the wafer moves in the other direction, as shown in FIG. 10D.

The adverse situations shown in FIGS. 10C and 10D can be avoided by designing the seal to resist the maximum pressure produced by the immersion fluid on the ferrofluid, and by avoiding conditions where the interfacial surface (the surface where the ferrofluid and immersion fluid contact each other) becomes unstable.

In addition, the interface between the ferrofluid, wafer and air must not become unstable. This is ensured by proper selection of the fluid properties of the ferrofluid plus the stabilizing force of the magnetic field. Ideally, the ferrofluid should have a large contact angle with the wafer so it does not wet the wafer. It also is helpful if the ferrofluid has a relatively low viscosity. The dynamic contact angle also should be neither very large nor very small, so that the static contact angle is preferably about 90 degrees. Therefore, the surface tensions of the immersion fluid and the ferrofluid should not be very different, although the magnetic field effects reduce the sensitivity of this requirement. Satisfying these conditions simultaneously may not always be possible, and an empirical compromise may be required.

If the density of the ferrofluid is less than that of the immersion fluid, an instability can occur in the interface between the fluids, as opposed to one between the fluids and the wafer surface. This may cause the two fluids to intennix and also may cause the immersion fluid to penetrate the ferrofluidic seal. This is known as a Rayleigh-Taylor instability, and a classic example is of a denser fluid sitting on top of a lighter fluid in a gravitational field. Fingers of fluid from both sides can rapidly penetrate the fluid interface. The instability develops if the horizontal extent of the fluid interface exceeds the Taylor wavelength λ_{T} according to the following equation (4):

λ_{T}=2π[gΔρ/γ]^{1/2}, (4)

where Δρ is the fluid density difference and γ is the interfacial tension. In our situation, the acceleration of gravity g in equation (4) is replaced by the acceleration of the immersion fluid imposed by the ferrofluid seal.

In an immersion lithography application, if immersion fluid escapes from the nozzle during stage acceleration, the immersion fluid will apply a force on the ferrofluid with some related acceleration value, and the above analysis applies. This instability should not be a serious issue because:
The densities of the ferrofluid and immersion fluid can be relatively similar, leading to a large Taylor wavelength, and a ferrofluid can be chosen that is denser than the immersion fluid so as to avoid the instability altogether. For example, if the immersion fluid is water, a preferable ferrofluid is a water based ferrofluid (the ferromagnetic particles in the ferrofluid increase the ferrofluid density significantly).
If the magnetic field lines are approximately parallel to the fluid interface, the magnetic field will stabilize the fluid interface significantly, increasing the Taylor wavelength even further.
Additional stability can be provided if the magnetic field strength increases in the direction from the interface into the ferrofluid. In particular, the instability will be suppressed if the following condition (5) is satisfied:

μ₀M|∇H|>aΔρ (5)

where M is the magnetization of the ferrofluid, ∇H is the magnetic field gradient normal to the interface surface, and a is the effective acceleration exerted on the fluids by the stage acceleration.

The above description applies to an application where the ferrofluid seal is used to contain the main body of the immersion fluid. In another application, the immersion fluid may be largely contained by the immersion nozzle, and the ferrofluid seal functions mainly to contain relatively small quantities of immersion fluid which escape from the nozzle during stage scanning. The seal stability is then essentially unaffected by the immersion fluid.

In one embodiment the ferrofluid liquid may be miscible with the immersion fluid, and may even be the immersion fluid. In that case small droplets of escaped immersion fluid will be absorbed into the ferrofluid and eventually removed from the system as the ferrofluid is refreshed. The absorption represents a temporary and local dilution of the ferromagnetic particles. A large dilution of the ferrofluid can lead to a seal breakdown. However, for relatively small quantities of fluid, this should not occur.

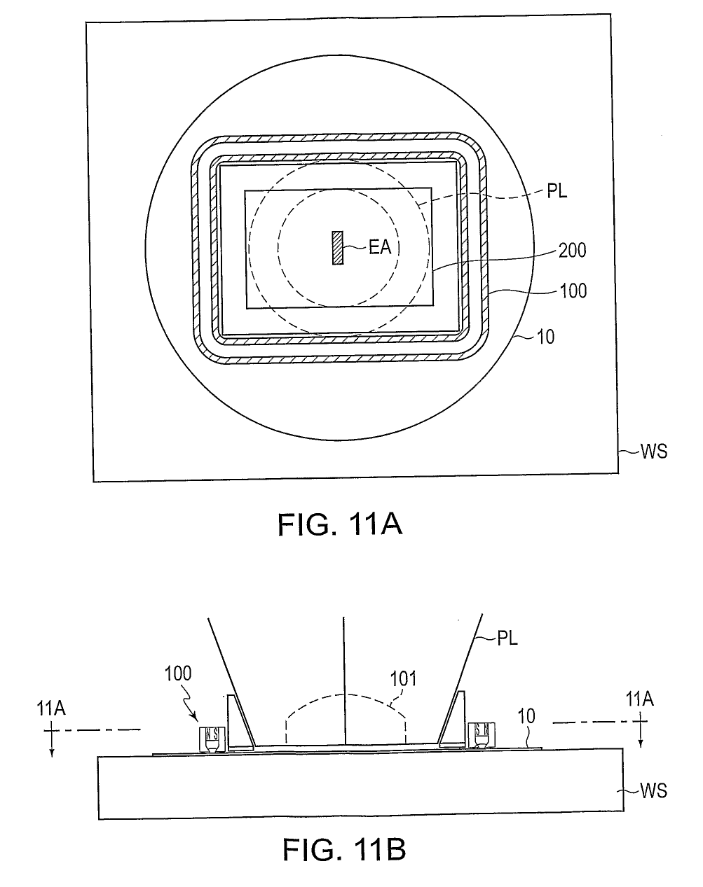

FIG. 11A is a top view showing a ferrofluidic seal 100 surrounding the immersion fluid nozzle 200 of a lithography apparatus. FIG. 11B is a side view of the FIG. 11A apparatus. As shown in these figures, an immersion fluid is provided by the immersion nozzle 200 to an immersion area formed in the gap located between the last optical element 101 of a projection optical system PL and the upper surface of a substrate 10 that is mounted on and moved by a wafer stage WS. During exposure, an exposure area EA is formed by the irradiation energy in a slit-shaped area within the immersion area, as is known. In the embodiment of FIGS. 11A and 11B, the ferrofluidic seal 100 is a continuous seal that entirely surrounds the immersion area. The pole pieces 120, 130 and the magnet 140 of the ferrofluidic seal can be attached to the immersion fluid nozzle 200.

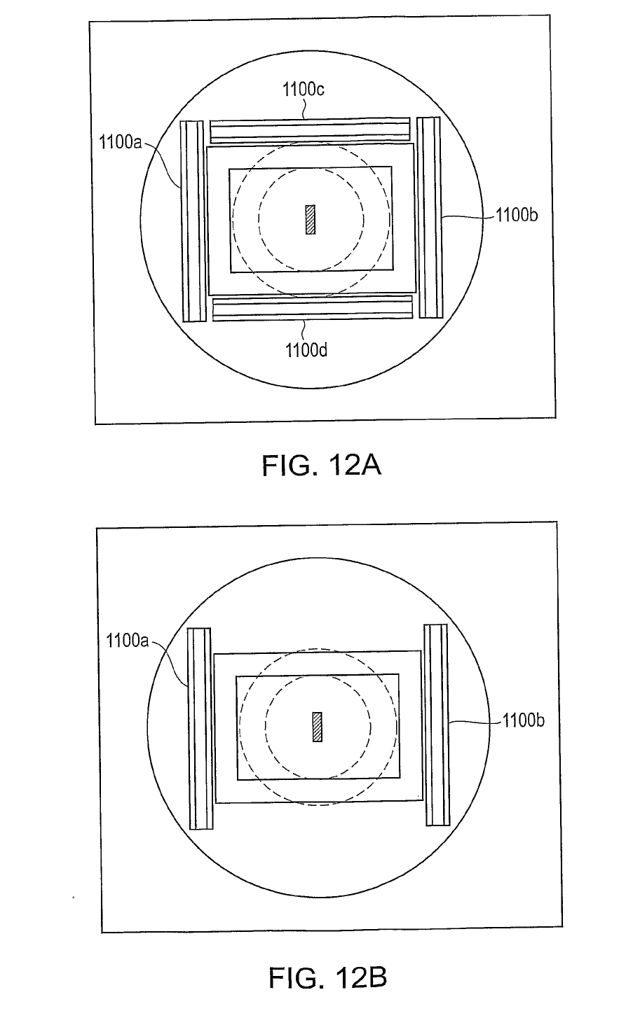

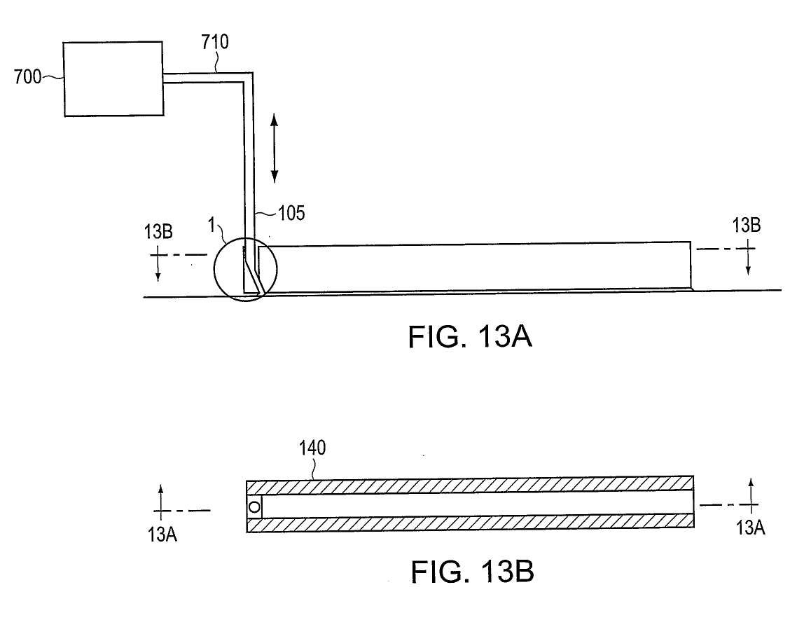

FIG. 12A shows an alternative embodiment in which a ferrofluidic seal discontinuously surrounds the immersion area. In particular, four separate ferrofluidic seals 1100a-1100d are formed, one on each of four sides of the immersion area. These seals also can be attached to the immersion fluid nozzle.

FIG. 12B shows another alternative in which two ferrofluidic seals 1100a, 1100b are formed, each on opposite sides of the immersion area. The ferrofluidic seals of FIG. 12B each extend in a direction that is perpendicular to the scanning direction in which the wafer stage WS moves the substrate 10 during exposure of the substrate. (In FIGS. 12A and 12B, the scanning direction is the left-right direction.) In the embodiments of FIGS. 11A-12B, the ferrofluid is constrained at the ends of each of the magnetic structures by the decreasing strength of the magnetic field, in the same manner that it is constrained laterally. In other words, the stronger magnetic field beneath the magnetic structures retains the ferrofluid at the narrow ends of the structures as well as at the long sides of the structures.

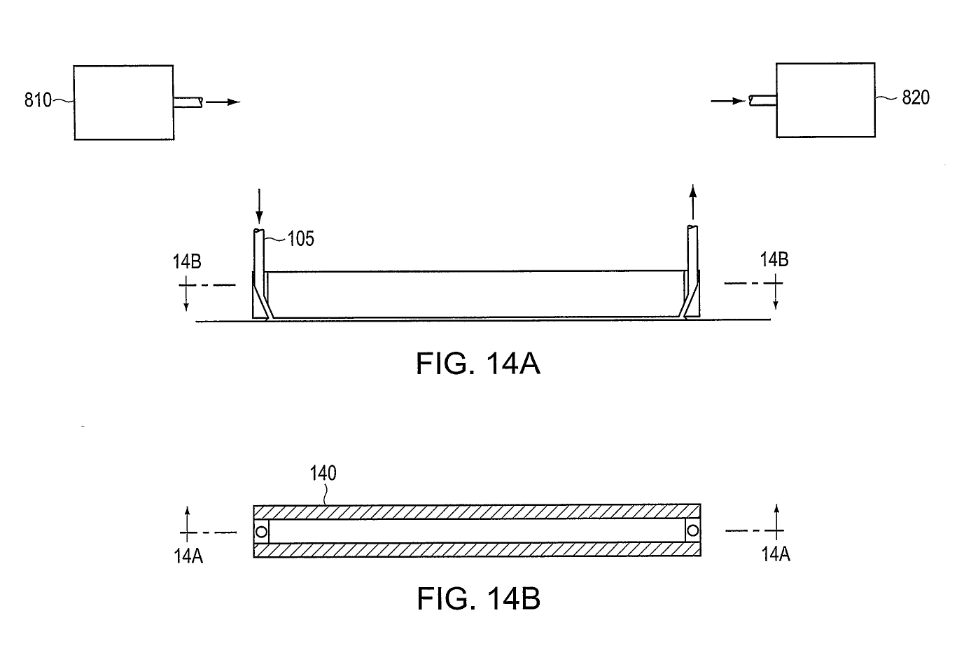

FIGS. 13A and 13B are provided to demonstrate one manner for initially loading ferrofluid into the magnetic field. A pump 700 supplies ferrofluid 105 from a reservoir through a tube 710 into the magnetic field at the end of the permanent magnet 140, where it is drawn into the more intense regions of the magnetic field. If too much fluid is supplied, some of it may leak out of the magnetic field and be lost. If too little fluid is supplied, the burst pressure (the pressure at which the immersion fluid will be expelled through the ferrofluidic seal) will be reduced. Proper calibration will allow the appropriate amount of ferrofluid to be supplied.

It may be more difficult to remove the ferrofluid from the magnetic circuitry. In the region 1 shown in FIG. 13A, the magnetic field is decreasing rapidly, so magnetic forces try to retain the fluid in the seal region. The magnetic forces can exceed the surface tension forces, so the fluid may separate with part of it withdrawn to the pump and part of it remaining in the magnetic field region. If the magnetic field region 1 extends to where the fluid is within the tube 710, the pressure difference between the pump 700 and atmosphere will allow the fluid to be withdrawn, because the maximum burst pressure of the seal is only a few psi. The seal structure can be designed to extend the magnetic field as described, or an auxiliary electromagnet can be energized for ferrofluid removal.

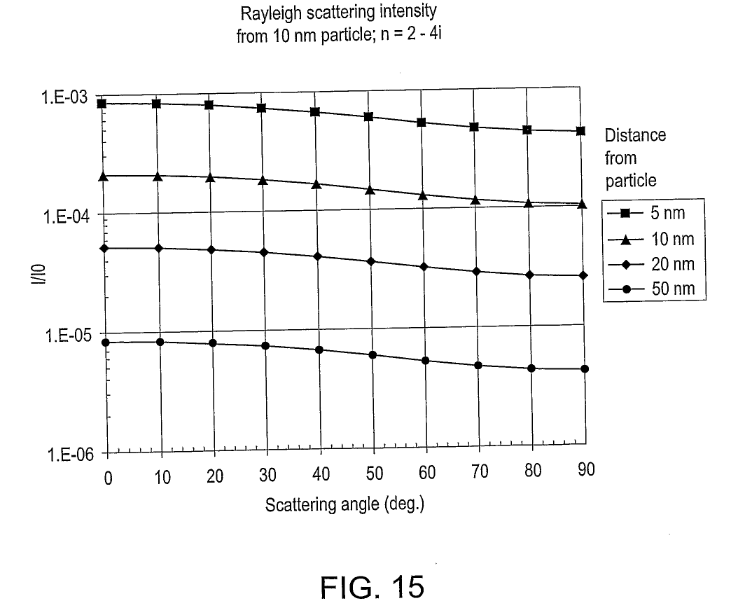

It may be desirable to circulate the ferrofluid continuously or periodically to avoid contamination by/of the resist. FIGS. 14A and 14B illustrate an arrangement in which the ferrofluid is circulated by pumps 810, 820 to reservoirs and filters, for example.

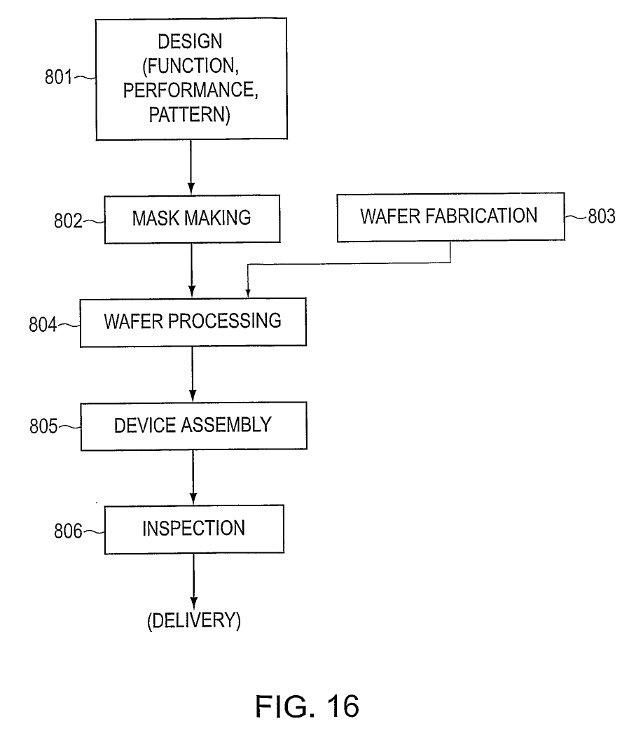

Ideally after exposure, when the wafer is removed from the exposure apparatus, the immersion fluid should be completely removed from the wafer, as should the ferrofluid, although this may not always occur. One possible complication of the ferrofluid is the effect that residual ferrite particles left on the surface of the wafer would have during an exposure. Barring chemical interactions with the photoresist, the 10 nm particles seem to be too small to have any direct effect on the exposure. FIG. 15 shows the scattered radiation intensity from a 10 nm particle illuminated by 193 nm light in the Rayleigh scattering approximation (from H. C. van de Hulst, Light Scattering by Small Particles). The scattered radiation intensity is shown at several distances from the particle. The intensity is less than 0.1% 5 nm from the center of the particle, i.e., at the top of the photoresist, and it decreases rapidly at greater distances. The results are shown for a complex index of refraction of 2-4i; the actual value for ferrite at 193 nm is not known. Varying the index changes the results by only about a factor of 2. Therefore the likelihood of it producing an image is small.

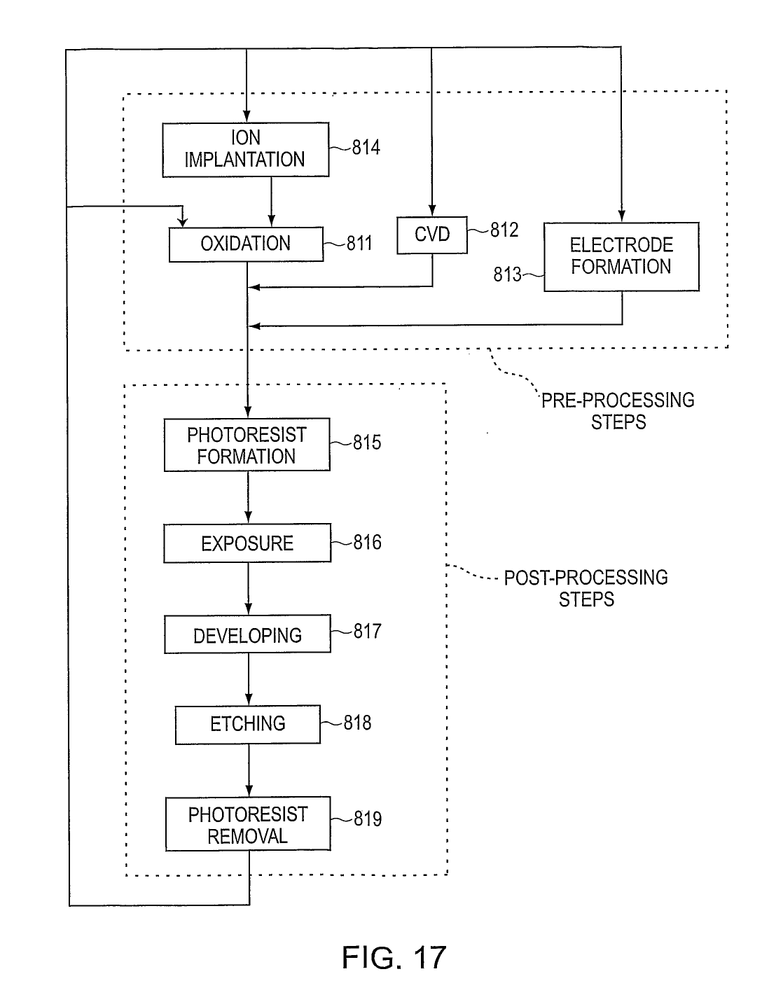

Semiconductor devices can be fabricated using the above described systems, by the process shown generally in FIG. 16. In step 801 the device's function and performance characteristics are designed. Next, in step 802, a mask (reticle) having a pattern is designed according to the previous designing step, and in step 803a wafer is made from a silicon material. The mask pattern designed in step 802 is exposed onto the wafer from step 803 in step 804 by a photolithography system described hereinabove in accordance with embodiments of the invention. In step 805 the semiconductor device is assembled (including the dicing process, bonding process and packaging process). Finally, the device is then inspected in step 806.

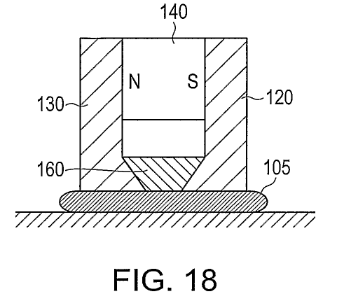

FIG. 17 illustrates a detailed flowchart example of the above-mentioned step 804 in the case of fabricating semiconductor devices. In FIG. 17, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. A fluid control system for immersion lithography in which a portion of a surface located in an immersion area is exposed to irradiation while an immersion liquid is supplied to a gap disposed between an optical member and the portion of the surface located in the immersion area, the fluid control system comprising:
a ferrofluidic seal located adjacent to the immersion area and that is formed from a ferrofluid that is different from the immersion fluid.

2. The fluid control system of claim 1, wherein the ferrofluidic seal is located adjacent to at least one side of the immersion area.

3. The fluid control system of claim 1, wherein the ferrofluidic seal is located adjacent to at least two opposite sides of the immersion area.

4. The fluid control system of claim 1, wherein the ferrofluidic seal is a continuous seal that entirely surrounds the immersion area.

5. The fluid control system of claim 1, wherein the ferrofluidic seal is a discontinuous seal that extends around the immersion area.

6. The fluid control system of claim 1, wherein the ferrofluid includes a liquid with a colloidal suspension of ferromagnetic particles.

7. The fluid control system of claim 6, wherein the liquid of the ferrofluid is selected from the group consisting of water, hydrocarbons, fluorocarbons, esters, polyphenylethers and di-esters.

8. The fluid control system of claim 6, wherein the liquid of the ferrofluid is water.

9. The fluid control system of claim 6, wherein the ferromagnetic particles are selected from the group consisting of ferrite, cobalt, iron-cobalt alloy, and paramagnetic salts.

10. The fluid control system of claim 1, wherein the ferrofluid is immiscible with the immersion fluid.

11. The fluid control system of claim 1, wherein the ferrofluid has a density that is equal to or greater than a density of the immersion fluid.

12. The fluid control system of claim 1, wherein the ferrofluidic seal includes the ferrofluid and a magnetic circuit that draws the ferrofluid to a location adjacent to the immersion area.

13. The fluid control system of claim 12, wherein the magnetic circuit includes (i) a high magnetic permeability plate located such that the surface that is to be exposed is disposed between the optical member and the high magnetic permeability plate, (ii) high magnetic permeability pole pieces located adjacent to the optical member and facing the surface to be exposed, and (iii) a magnet that magnetizes the pole pieces.

14. The fluid control system of claim 13, wherein the magnet is a permanent magnet.

15. The fluid control system of claim 12, wherein the magnetic circuit includes (i) high magnetic permeability pole pieces located adjacent to the optical member and facing the surface to be exposed, the ferrofluid located between the pole pieces such that the ferrofluid is lifted off the surface by the pole pieces when the pole pieces and the surface are moved away from each other, and (ii) a magnet that magnetizes the pole pieces.

16. The fluid control system of claim 15, wherein the magnet is a permanent magnet.

17. The fluid control system of claim 15, wherein the magnetic circuit further comprises an electromagnet located such that the surface that is to be exposed is disposed between the optical member and the electromagnet.

18. The fluid control system of claim 15, wherein the magnetic circuit further comprises a pump that controls a pressure within a chamber formed between the pole pieces so as to selectively (a) increase the pressure to allow the ferrofluid to contact the surface and form the ferrofluidic seal and (b) decrease the pressure to cause the ferrofluid to move into the chamber and out of contact with the surface.

19. The fluid control system of claim 15, further comprising a non-ferromagnetic plug disposed between the high magnetic permeability pole pieces, wherein the ferrofluid collects between the plug and the surface to be exposed.

20. The fluid control system of claim 12, wherein the magnetic circuit includes (i) first, second and third high magnetic permeability pole pieces located adjacent to the optical member and facing the surface to be exposed, the third pole piece disposed between the first and second pole pieces, (ii) a first magnet disposed between the first and third pole pieces, and (iii) a second magnet disposed between the second and third pole pieces, wherein the ferrofluid collects between a lower surface of the third pole piece and the surface to be exposed.

21. The fluid control system of claim 20, further comprising non-ferromagnetic members attached to opposite sides of the third pole piece, to further retain the ferrofluid below the lower surface of the third pole piece.

22. The fluid control system of claim 1, further comprising a plurality of the ferrofluidic seals disposed in series so as to be located progressively farther away from the immersion area.

23. The fluid control system of claim 22, wherein each of at least two opposite sides of the immersion area have the plurality of ferrofluidic seals.

24. The fluid control system of claim 22, wherein each of the plurality of ferrofluidic seals is a continuous seal that entirely surrounds the immersion area, the plurality of ferrofluidic seals being concentric to each other.

25. The fluid control system of claim 1, further comprising:
a ferrofluid supply system that selectively supplies the ferrofluid to, and removes the ferrofluid from, the ferrofluidic seal.

26. An immersion lithography apparatus for transferring an image to a substrate, the apparatus comprising:
a projection optical system that projects the image onto the substrate;
a substrate stage that holds the substrate;
an immersion fluid supply system that supplies an immersion fluid to a portion of a surface of the substrate located in an immersion area that is between the substrate and a last optical element of the projection optical system; and
a ferrofluidic seal located adjacent to the immersion area and that is formed from a ferrofluid that is different from the immersion fluid.

27. The immersion lithography apparatus of claim 26, wherein the ferrofluidic seal is located adjacent to at least one side of the immersion area.

28. The immersion lithography apparatus of claim 26, wherein the ferrofluidic seal is located adjacent to at least two opposite sides of the immersion area.

29. The immersion lithography apparatus of claim 26, wherein the ferrofluidic seal is a continuous seal that entirely surrounds the immersion area.

30. The immersion lithography apparatus of claim 26, wherein the ferrofluidic seal is a discontinuous seal that extends around the immersion area.

31. The immersion lithography apparatus of claim 26, wherein the ferrofluid includes a liquid with a colloidal suspension of ferromagnetic particles.

32. The immersion lithography apparatus of claim 31, wherein the liquid of the ferrofluid is selected from the group consisting of water, hydrocarbons, fluorocarbons, esters, polyphenylethers and di-esters.

33. The immersion lithography apparatus of claim 31, wherein the liquid of the ferrofluid is water.

34. The immersion lithography apparatus of claim 31, wherein the ferromagnetic particles are selected from the group consisting of ferrite, cobalt, iron-cobalt alloy, and paramagnetic salts.

35. The immersion lithography apparatus of claim 26, wherein the ferrofluid is immiscible with the immersion fluid.

36. The immersion lithography apparatus of claim 26, wherein the ferrofluid has a density that is equal to or greater than a density of the immersion fluid.

37. The immersion lithography apparatus of claim 26, wherein the ferrofluidic seal includes the ferrofluid and a magnetic circuit that draws the ferrofluid to a location adjacent to the immersion area.

38. The immersion lithography apparatus of claim 37, wherein the magnetic circuit includes (i) a high magnetic permeability plate located in the substrate stage such that the substrate is disposed between the last optical element and the high magnetic permeability plate, (ii) high magnetic permeability pole pieces located adjacent to the projection optical system and facing the surface to be exposed, and (iii) a magnet that magnetizes the pole pieces.

39. The immersion lithography apparatus of claim 38, wherein the magnet is a permanent magnet.

40. The immersion lithography apparatus of claim 37, wherein the magnetic circuit includes (i) high magnetic permeability pole pieces located adjacent to the projection optical system and facing the surface to be exposed, the ferrofluid located between the pole pieces such that the ferrofluid is lifted off the surface by the pole pieces when the pole pieces and the surface are moved away from each other, and (ii) a magnet that magnetizes the pole pieces.

41. The immersion lithography apparatus of claim 40, wherein the magnet is a permanent magnet.

42. The immersion lithography apparatus of claim 40, wherein the magnetic circuit further comprises an electromagnet located such that the substrate is disposed between the last optical element and the electromagnet.

43. The immersion lithography apparatus of claim 40, wherein the magnetic circuit further comprises a pump that controls a pressure within a chamber formed between the pole pieces so as to selectively (a) increase the pressure to allow the ferrofluid to contact the surface and form the ferrofluidic seal and (b) decrease the pressure to cause the ferrofluid to move into the chamber and out of contact with the surface.

44. The immersion lithography apparatus of claim 40, further comprising a non-ferromagnetic plug disposed between the high magnetic permeability pole pieces, wherein the ferrofluid collects between the plug and the surface to be exposed.

45. The immersion lithography apparatus of claim 37, wherein the magnetic circuit includes (i) first, second and third high magnetic permeability pole pieces located adjacent to the projection optical system and facing the surface to be exposed, the third pole piece disposed between the first and second pole pieces, (ii) a first magnet disposed between the first and third pole pieces, and (iii) a second magnet disposed between the second and third pole pieces, wherein the ferrofluid collects between a lower surface of the third pole piece and the surface to be exposed.

46. The immersion lithography apparatus of claim 45, further comprising non-ferromagnetic members attached to opposite sides of the third pole piece, to further retain the ferrofluid below the lower surface of the third pole piece.

47. The immersion lithography apparatus of claim 26, further comprising a plurality of the ferrofluidic seals disposed in series so as to be located progressively farther away from the immersion area.

48. The immersion lithography apparatus of claim 47, wherein each of at least two opposite sides of the immersion area have the plurality of ferrofluidic seals.

49. The immersion lithography apparatus of claim 47, wherein each of the plurality of ferrofluidic seals is a continuous seal that entirely surrounds the immersion area, the plurality of ferrofluidic seals being concentric to each other.

50. A method of retaining immersion fluid in an immersion area during an immersion lithography process in which a portion of a surface located in the immersion area is exposed to irradiation while the immersion liquid is supplied to a gap disposed between an optical member and the portion of the surface located in the immersion area, the method comprising:
forming a ferrofluidic seal adjacent to the immersion area, the ferrofluidic seal being formed from a ferrofluid that is different from the immersion fluid.

51. The method of claim 50, wherein the ferrofluidic seal is located adjacent to at least one side of the immersion area.

52. The method of claim 50, wherein the ferrofluidic seal is located adjacent to at least two opposite sides of the immersion area.

53. The method of claim 50, wherein the ferrofluidic seal is a continuous seal that entirely surrounds the immersion area.

54. The method of claim 50, wherein the ferrofluidic seal is a discontinuous seal that extends around the immersion area.

55. The method of claim 50, wherein the ferrofluid includes a liquid with a colloidal suspension of ferromagnetic particles.

56. The method of claim 55, wherein the liquid of the ferrofluid is selected from the group consisting of water, hydrocarbons, fluorocarbons, esters, polyphenylethers and diesters.

57. The method of claim 55, wherein the liquid of the ferrofluid is water.

58. The method of claim 55, wherein the ferromagnetic particles are selected from the group consisting of ferrite, cobalt, iron-cobalt alloy, and paramagnetic salts.

59. The method of claim 50, wherein the ferrofluid is immiscible with the immersion fluid.

60. The method of claim 50, wherein the ferrofluid has a density that is equal to or greater than a density of the immersion fluid.

61. The method of claim 50, wherein the ferrofluidic seal is formed by providing a magnetic circuit that draws the ferrofluid to a location adjacent to the immersion area.

62. The method of claim 61, wherein the magnetic circuit includes (i) a high magnetic permeability plate located such that the surface that is to be exposed is disposed between the optical member and the high magnetic permeability plate, (ii) high magnetic permeability pole pieces located adjacent to the optical member and facing the surface to be exposed, and (iii) a magnet that magnetizes the pole pieces.

63. The method of claim 62, wherein the magnet is a permanent magnet.

64. The method of claim 61, wherein the magnetic circuit includes (i) high magnetic permeability pole pieces located adjacent to the optical member and facing the surface to be exposed, the ferrofluid located between the pole pieces such that the ferrofluid is lifted off the surface by the pole pieces when the pole pieces and the surface are moved away from each other, and (ii) a magnet that magnetizes the pole pieces.

65. The method of claim 64, wherein the magnet is a permanent magnet.

66. The method of claim 64, wherein the magnetic circuit further comprises an electromagnet located such that the surface that is to be exposed is disposed between the optical member and the electromagnet.

67. The method of claim 64, further comprises using a pump to control a pressure within a chamber formed between the pole pieces so as to selectively (a) increase the pressure to allow the ferrofluid to contact the surface and form the ferrofluidic seal and (b) decrease the pressure to cause the ferrofluid to move into the chamber and out of contact with the surface.

68. The method of claim 64, wherein a non-ferromagnetic plug is disposed between the high magnetic permeability pole pieces, wherein the ferrofluid collects between the plug and the surface to be exposed.

69. The method of claim 61, wherein the magnetic circuit includes (i) first, second and third high magnetic permeability pole pieces located adjacent to the optical member and facing the surface to be exposed, the third pole piece disposed between the first and second pole pieces, (ii) a first magnet disposed between the first and third pole pieces, and (iii) a second magnet disposed between the second and third pole pieces, wherein the ferrofluid collects between a lower surface of the third pole piece and the surface to be exposed.

70. The method of claim 69, wherein non-ferromagnetic members are attached to opposite sides of the third pole piece, to further retain the ferrofluid below the lower surface of the third pole piece.

71. The method of claim 50, wherein a plurality of the ferrofluidic seals are disposed in series so as to be located progressively farther away from the immersion area.

72. The method of claim 71, wherein each of at least two opposite sides of the immersion area have the plurality of ferrofluidic seals.

73. The method of claim 71, wherein each of the plurality of ferrofluidic seals is a continuous seal that entirely surrounds the immersion area, the plurality of ferrofluidic seals being concentric to each other.

74. The method of claim 50, further comprising:
selectively supplying the ferrofluid to, and removing the ferrofluid from, the ferrofluidic seal.
